(19) United States
(12) Patent Application Publication
(10) Pub. No.: US 2007/0150359 A1
(43) Pub. Date: Jun. 28, 2007

(54) Social marketing network

(76) Inventors: Kok Eng Samuel Lim, Singapore (SG); Hur Kuang Michael Ewing-Chow, Singapore (SG); Teddy Abdurachim Jasin, Singapore (SG); Zaidah Mohd, Singapore (SG); Torres Arifin Oey, Singapore (SG); Wee Ming Ong, Singapore (SG); Heng Soon Shi, Singapore (SG); Julian Gerard Vincent, Kuala Lumpur (MY); Kian San Christopher Vu, Singapore (SG); Heling William Zhang, Singapore (SG)

Correspondence Address: Stephen M. De Klerk;Blakely Sokoloff Taylor & Zafman, Seventh Floor, 12400 Wilshire Boulevard, Los Angeles, CA, 90025, US

(21) Appl. No.: 11/233,855

(22) Filed: Sep. 9, 2005

(51) Int. Cl. G06Q 30/00

(52) U.S. Cl. 705/26

(57) ABSTRACT

A social marketing network (5) for marketing digital content (6, 7, 8) the network (5) comprising: a first shop (10) to sell particular digital content (6, 7, 8); a plurality of second shops (15, 20, 25) to sell the particular digital content (6, 7, 8), the second shops (15, 20, 25) being affiliated to the first shop (10) and classified in levels relative to the first shop (10); wherein the particular digital content (6, 7, 8) is available for re-sale at any shop (10, 15, 20, 25) within the social marketing network (5) and the revenue earned by the first shop (10) is determined by a predetermined commission scale based on the level of the shop (10, 15, 20, 25) which sold the particular digital content (6, 7, 8) relative to the first shop (10).

### TECHNICAL FIELD

The invention concerns a social marketing network for marketing digital content.

### BACKGROUND OF THE INVENTION

People have varied interests and hobbies. One way to share this with the public is to create a web site or a web log (blog). Web sites and blogs provide information to visitors and are sometimes entertaining.

Like minded people often congregate in web-based communities, portals or forums. These communities allow people to meet and communicate with other people with similar interests and tastes. These tools have gained widespread usage with the growth of the Internet.

There is a desire to leverage from people's social connections with one another and their appetite for information and entertainment, in order to generate income. In particular, as the Internet as a communication medium consolidates, there is a desire to extend information and entertainment services to mobile communications devices where they may be purchased on demand, regardless of geographic location.

### SUMMARY OF THE INVENTION

In a first preferred aspect, there is provided a social marketing network for marketing digital content, the network comprising:
a first shop to sell particular digital content;
a plurality of second shops to sell the particular digital content, the second shops being affiliated to the first shop and classified in levels relative to the first shop;
wherein the particular digital content is available for re-sale at any shop within the social marketing network and the revenue earned by the first shop is determined by a predetermined commission scale based on the level of the shop which sold the particular digital content relative to the first shop.

An author of the particular digital content may receive a predetermined commission rate of the purchase price.

The second shops may be affiliated to the first shop by any one from the group consisting of: referral or introduction and agreed form of affiliation to the social marketing network.

Revenue earned from the sale of particular digital content may be paid in the form of virtual money exchangeable for real money after a predetermined waiting period and subject to conditions and policies of the network.

Digital content may be purchased using a form of credit or cash acceptable within the network.

The particular digital content may be any one from the group consisting of: ringtone, wallpaper, theme, application, image, audio file, video file, game, document, text, a weblink or waplink URL, any form of rich media, and pincodes.

The particular digital content may be centrally stored to facilitate tracking of the distribution of the particular digital content.

The shops may be linkable from external sites.

If a shop breaches a policy of the social marketing network, the shop may be removed from the network and revenue earned by the shop is transferred to an operator of the network in accordance with prevailing network policies.

The network may further comprise a customer service module to monitor and filter digital content contravening a policy of the social marketing network, prior to publication for direct sale on the network.

The network may further comprise a WAP module to provide ubiquitous connectivity to the network by any device of the group consisting of: mobile phone, PDA, 3G device, interactive television, MP3 player, kiosks and terminals, wherein the WAP module extends the coverage of the network to global mobile communications networks.

The shops may be WAP sites or web sites.

In a second aspect, there is provided a method for earning revenue from selling digital content in a social marketing network, the method comprising:
selling particular digital content from a first shop;
determining the affiliation and the number of levels from the first shop relative to a second shop; and
calculating the revenue earned by the second shop by matching the level of the first shop to a predetermined commission scale;
wherein the particular digital content is available for re-sale at any shop within the social marketing network.

In a third aspect, there is provided an electronic shop for selling digital content, the electronic shop forming a social marketing network, the shop comprising:
a user interface to enable particular digital content to be purchased;
wherein the electronic shop is affiliated to other shops in the social marketing network and classified in levels relative to the other shops; and
the particular digital content is available for re-sale at any shop within the social marketing network and the revenue earned by the electronic shop by purchase of the particular digital content is determined by a predetermined commission scale based on the level of the shop which sold the particular digital content relative to the electronic shop.

In a fourth aspect, there is provided a billing platform for content providers to earn revenue from sale of digital content, the platform comprising:
a portal management module to establish: categories, links, country of origin and payment options for content driven sites;
wherein visitors to the content driven sites are charged according to the established payment options, the payment options being any one from the group consisting of: per event, per duration, fixed price per access, subscription access either daily, weekly, monthly or yearly or any predetermined time period.

The content driven sites may be WAP sites or web sites.

### BRIEF DESCRIPTION OF THE DRAWINGS

An example of the invention will now be described with reference to the accompanying drawings, in which:

FIGS. 1 and 2 are schematic diagrams of the social marketing network;

FIG. 3 is an schematic diagram illustrating affiliates of the social marketing network;

FIG. 4 is a first commission payout diagram of the social marketing network;

FIG. 5 is a second commission payout diagram of the social marketing network;

FIG. 6 is a royalty payout diagram of the social marketing network;

FIG. 7 is a screenshot of creating a shop in the social marketing network;

FIG. 8 is a screenshot of uploading content to the shop;

FIG. 9 is a screenshot of uploading a polyphonic ringtone to the shop;

FIG. 10 is a screenshot of uploading a wallpaper to the shop;

FIG. 11 is a screenshot of uploading a theme to the shop;

FIG. 12 is a screenshot of uploading an application to the shop;

FIG. 13 is a screenshot of uploading a video file to the shop;

FIG. 14 is a screenshot of uploading a game to the shop;

FIG. 15 is a screenshot of uploading an electronic book to the shop;

FIG. 16 is a screenshot of uploading an article to the shop;

FIG. 17 is a screenshot of uploading an MP3 ringtone to the shop;

FIG. 18 is a screenshot of browsing shops within the social marketing network;

FIG. 19 is a screenshot of selecting content from other shops to list on your own shop;

FIG. 20 is a screenshot of approving content before it is published on a shop for sale;

FIG. 21 is a process flow diagram of earning revenue through the sale of digital content in the social marketing network; and

FIGS. 22 and 23 are screenshots of a portal management module for a billing platform in accordance with a preferred embodiment of the present invention.

### DETAILED DESCRIPTION OF THE DRAWINGS

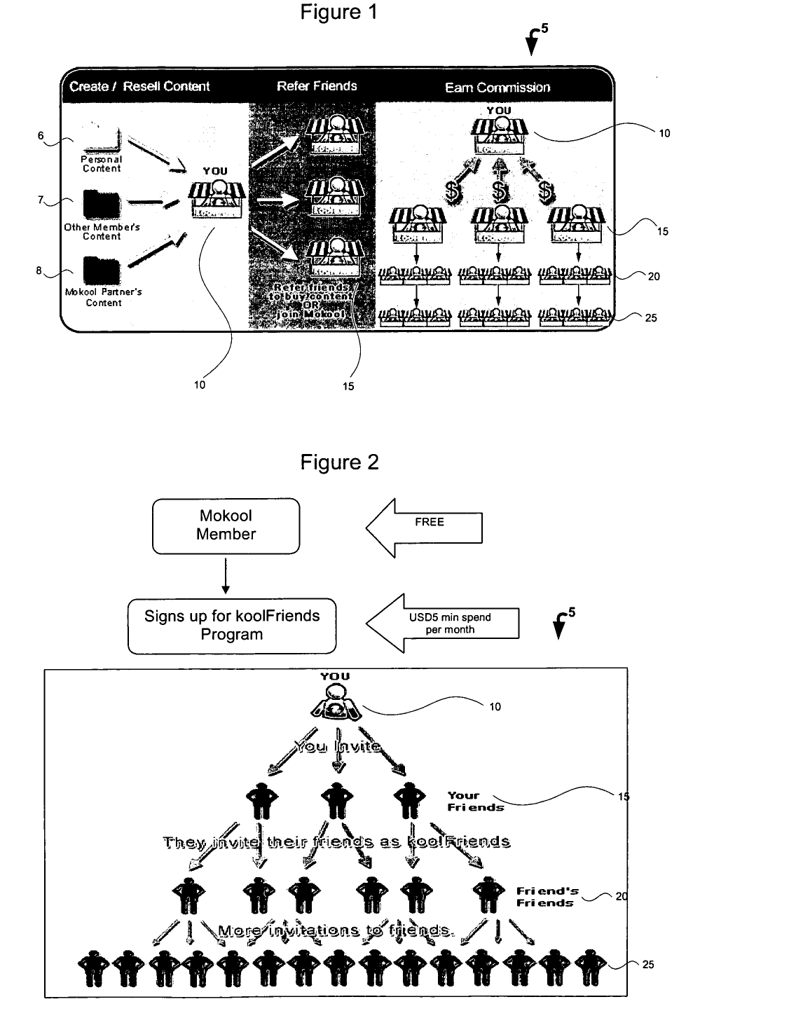

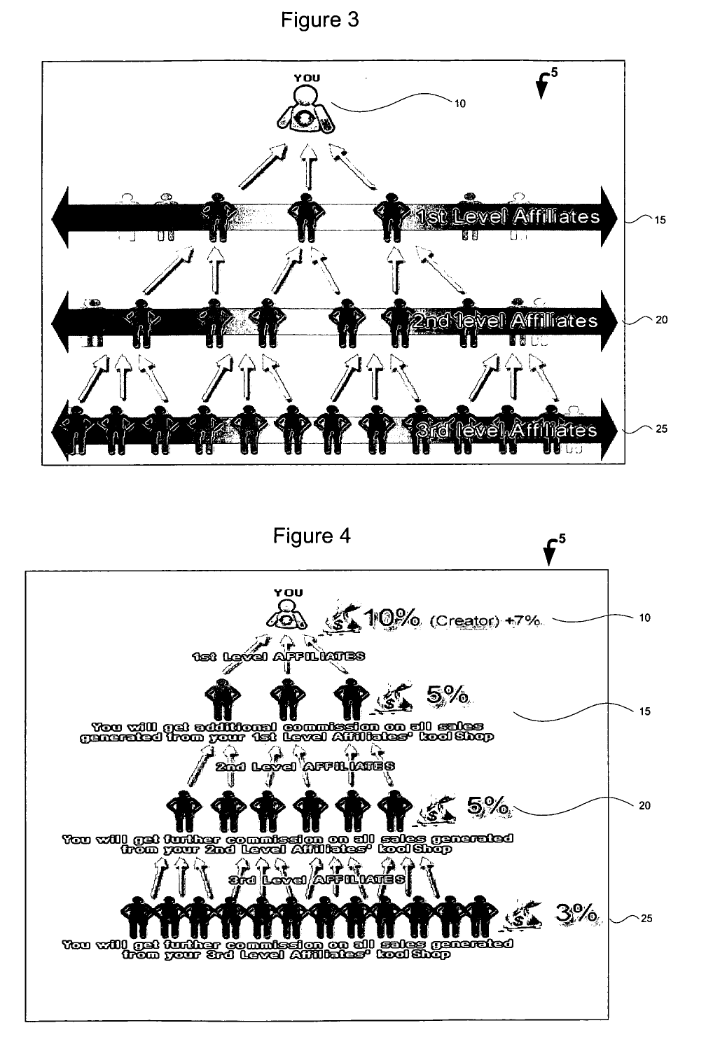

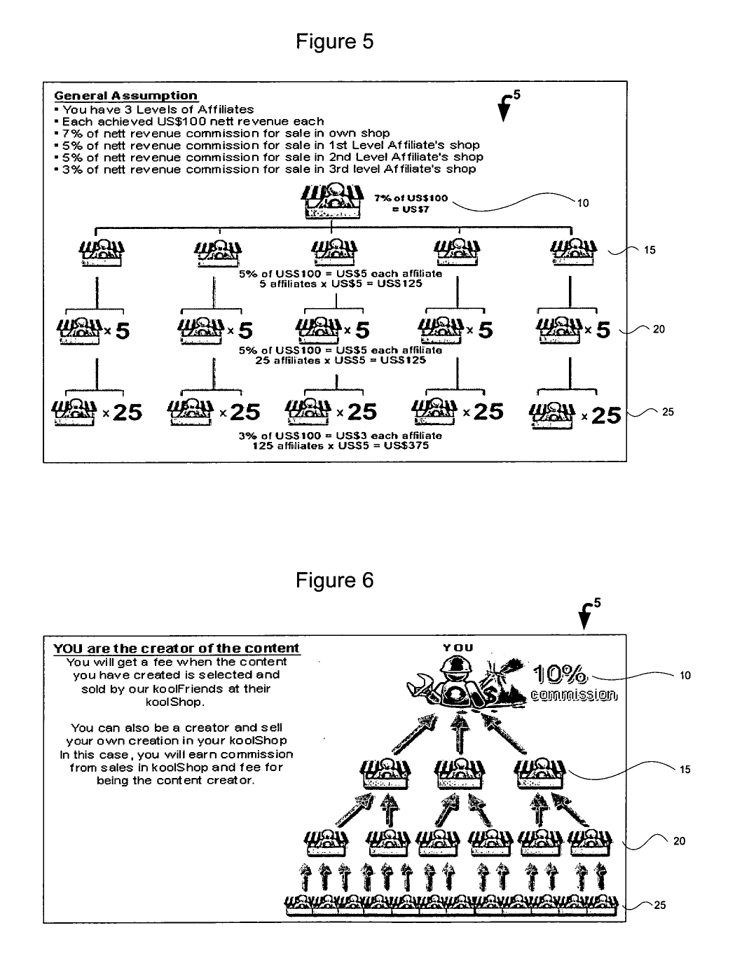

Referring to FIGS. 1 to 6, a social marketing network 5 for marketing digital content is provided. The social marketing network 5 is global, comprising a community of consumers and digital content creators. The network 5 comprises a plurality of shops 10, 15, 20, 25 owned by merchants or members. The shops are web-based and WAP-based, and are accessible from the Internet or via a mobile communications device such as a mobile phone or Personal Digital Assistant (PDA) and like devices. From the perspective of a first shop 10, a plurality of second shops 15 are affiliated to the first shop. A first shop may be considered a supplier of a particular digital content while a second shop may be considered a distributor of the particular digital content. The affiliation is created by the first shop member 10 referring or introducing the second shop members 15 to the social marketing network 5. The social marketing network 5 provides multi-directional distribution and marketing of digital content via any combination of communication networks such as the Internet, mobile phone network, wireless networks and the like.

Once a second shop member 15 joins the network 5, it effectively joins the private network of the first shop 10 and becomes a second tier affiliate for the first shop 10. This may be viewed as a parent-child relationship. Second shop members are able to refer or introduce other members 20, 25 to the social marketing network 5. The other members maintain a relationship with the first shop 10, and from the perspective of the first shop 10, this is viewed as a grandparent-grandchild relationship and from the perspective of the second shop 15, this is viewed as a parent-child relationship. The social marketing network 5 thus constitutes a plurality of affiliate levels. In one embodiment, the social marketing network 5 permits only four levels of affiliates for each shop to reduce the complexity of the system and payment process. However, content distribution is not limited by the number of levels as any shop in the network 5 is able to cross-sell to another. Each first shop 10 constitutes an apex node in the network 5 having their own sub-network of second shops. In the network 5, there is a plurality of apex nodes. The first shop 10 and second shops 15 are situated in these levels and for the purposes of calculating commissions payable to the first shop 10 for sale of particular digital content, the levels of the second shops 15, 20, 25 are determined relative to the level of the first shop 10. The revenue earned by the first shop 10 is determined by a predetermined commission scale based on the level of the shop which sold the particular digital content relative to the first shop 10 as depicted in FIG. 4. Revenue earned from the sale of the particular digital content is paid in the form of virtual money, for example, koolCash. The virtual money is exchangeable for real money after a predetermined waiting period. This minimises the risk of fraud, money laundering and other illegal activities. Digital content may be purchased using cash or a form of credit acceptable within the network 5, for example, koolCredit. The use of koolCredit encourages use of the network 5 to purchase digital content rather than having to take cash out. All members of the social marketing network 5 are automatically enrolled in the affiliate program. A predetermined minimum spending per month per member is required to enable the collection of commissions from sales of particular digital content in the affiliate program.

The shops in the social marketing network 5 sell particular digital content among other items to consumers or visitors to the network 5. The particular digital content is available for re-sale at any shop within the social marketing network 5. Turning to FIG. 1, the source of the particular digital content may originate from the shops' own content 6 (their own creation), other member's content 7 from other shops or a network partner's content 8. When a sale is made, the particular digital content is copied and transmitted to the purchaser from a central storage server or some other storage facility to facilitate tracking of the distribution of the particular digital content. The purchaser receives the particular digital content either as a file, in a SMS message, MMS message and so forth, on their mobile phone, PDA, notebook or desktop computer or other like devices.

Referring to FIG. 6, the author or creator of the particular digital content receives a predetermined commission rate of the purchase price. In one example, the author receives a 10% commission from the sale price.

Referring to FIG. 21, the process for earning revenue through the sale of particular digital content in the social marketing network is described. Digital content is published 70 for sale on a shop. The particular digital content may originate from the shop, or from another shop in the network 5. A visitor to the shop purchases 71 the particular digital content and pays the purchase price to the shop. The affiliation with other shops is determined 72 if the particular digital content does not originate from the shop, that is, it is re-sold from another shop. The affiliate level of the shop is compared 73 with a commission scale to calculate the appropriate commission to pay the shop. Referring back to FIG. 4, if the shop is a first level affiliate 10, it earns 7% revenue from the purchase price. If the shop is a second level affiliate 15 or third level affiliate 20, it earns 5% revenue from the purchase price. If the shop is a fourth level affiliate, it earns 3% revenue from the purchase price. Once the affiliate level is identified in the commission scale, the commission is paid 74 to the shop. The author of the particular digital content is paid 75 a 10% commission of the purchase price. The % commissions are merely embodiments and any predetermined payout structure may used. The predetermined payout structure may also be dynamic to respond to market conditions over time.

To increase market penetration, the shops in the social marketing network 5 are linkable from external sites. It is expected that many members may already have existing web/WAP sites such as pure content driven sites, and thus do not want to modify them. A link is placed on their existing site to their shop, which provides shop functionality, and payment management. Members are able to generate revenue they may otherwise forego, by allowing visitors to their content driven sites the ability to purchase items they author. For instance, a member is a car enthusiast, and creates digital content such as wallpapers of new concept cars or diagrams on how to implement a performance modification for a car. Previously, these digital content items are provided freely on the content driven site unless the member is able to add e-commerce functionality and payment methods and charge for these downloads. By placing the particular digital content on their shop for sale within the social marketing network, the e-commerce workload is shifted to a third party, similar to an application service provider (ASP) model. This allows members to concentrate on developing and creating content rather than implementing e-commerce functionality, marketing and distribution of their digital content.

Another way to increase market penetration is to allow members to attach digital content to their e-mails sent to friends. The digital content contains a link to the shop in the social marketing network 5. The digital content may incorporated in an e-mail signature.

The system provides tools for members to provide the e-mail link and personal web site link to the social marketing network 5.

If a shop breaches a policy of the social marketing network, the shop is removed from the social marketing network. Commissions that otherwise would be received by the removed shop are now accumulated by the operator of the social marketing network 5 and held in accordance with prevailing policies. Policies of the social marketing network may relate to security issues or legal issues such as copyright infringement, pornography, defamation or trademark infringement, harmful content (Malware) or expiry of credits, or expiry of membership. A policy for the operator of the network 5 to repatriate unclaimed revenue may also be implemented.

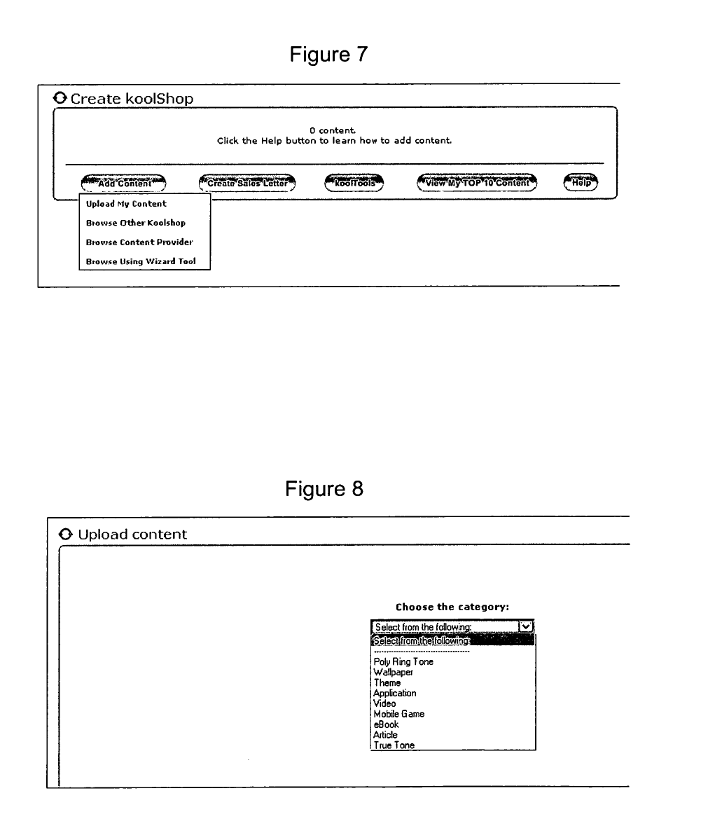

Referring to FIG. 7, a member creates a shop by uploading or using digital content from other shops in the social marketing network 5. This is done via a web interface. Each member selects their nickname to which they are referred to in the network 5. This nickname becomes a domain name for identification purposes of that particular member, for example, jewel.mokool.com, where jewel is the person's nickname. Shop tools are available to the member to customize the shop. A shop is created by any of the following options: member upload his/her/its content, browse other shop, browse partner and browse using wizard tool. The wizard tool simplifies the creation of a shop, as it assists the member in a step by step process. Shop statistics are also available to allow the member to monitor the sales of particular digital content and collect market intelligence.

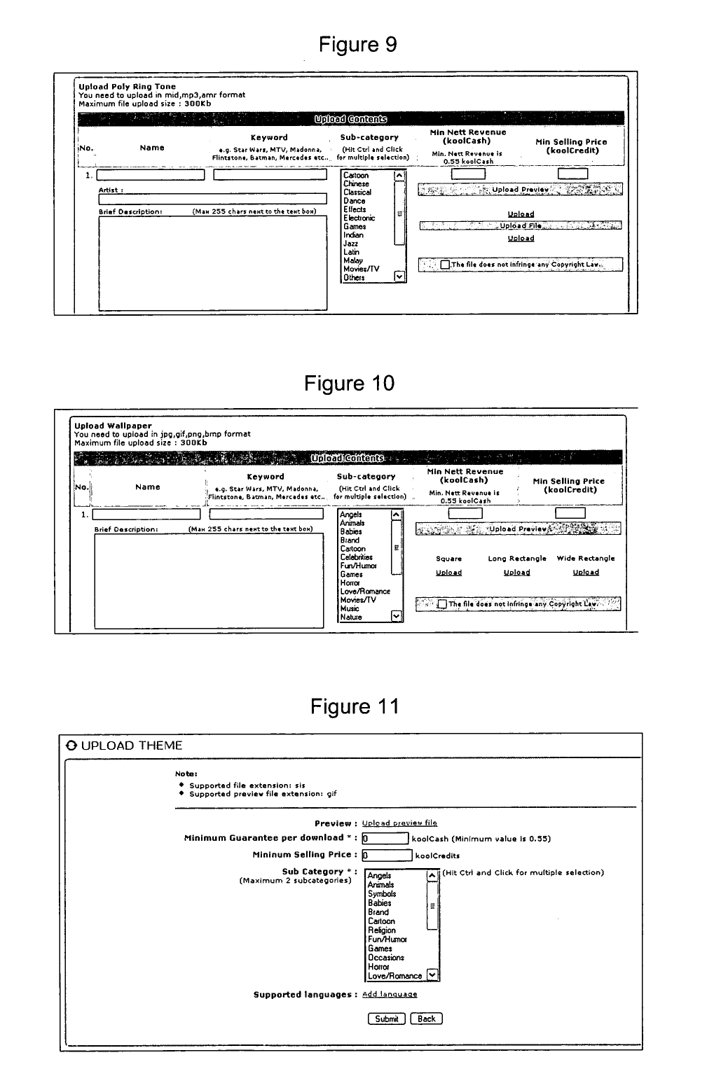

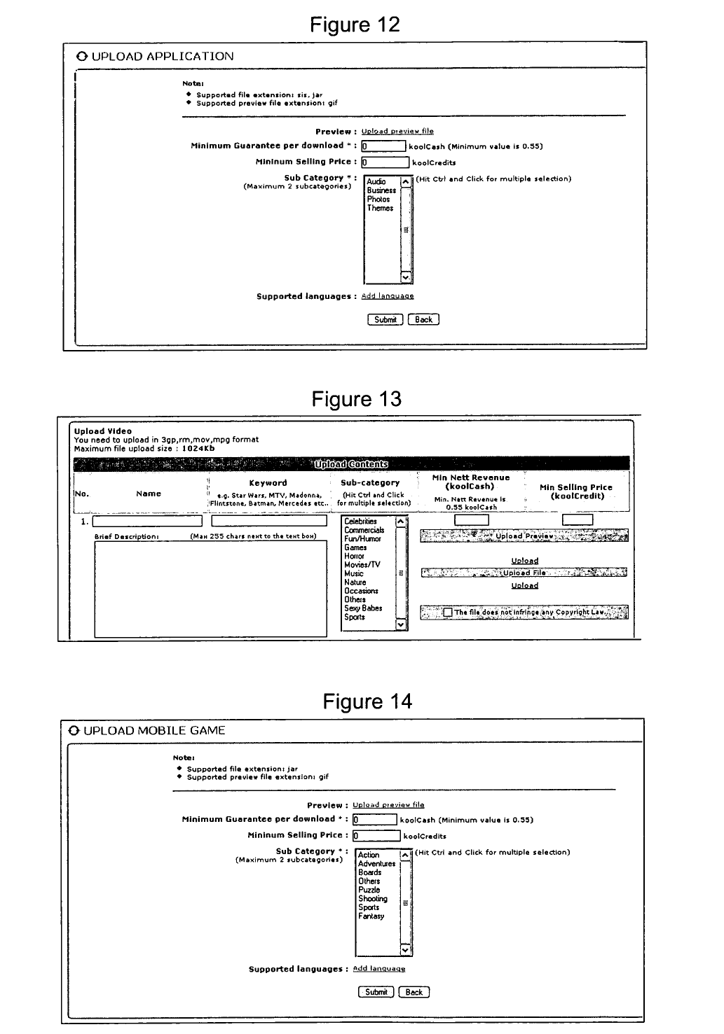

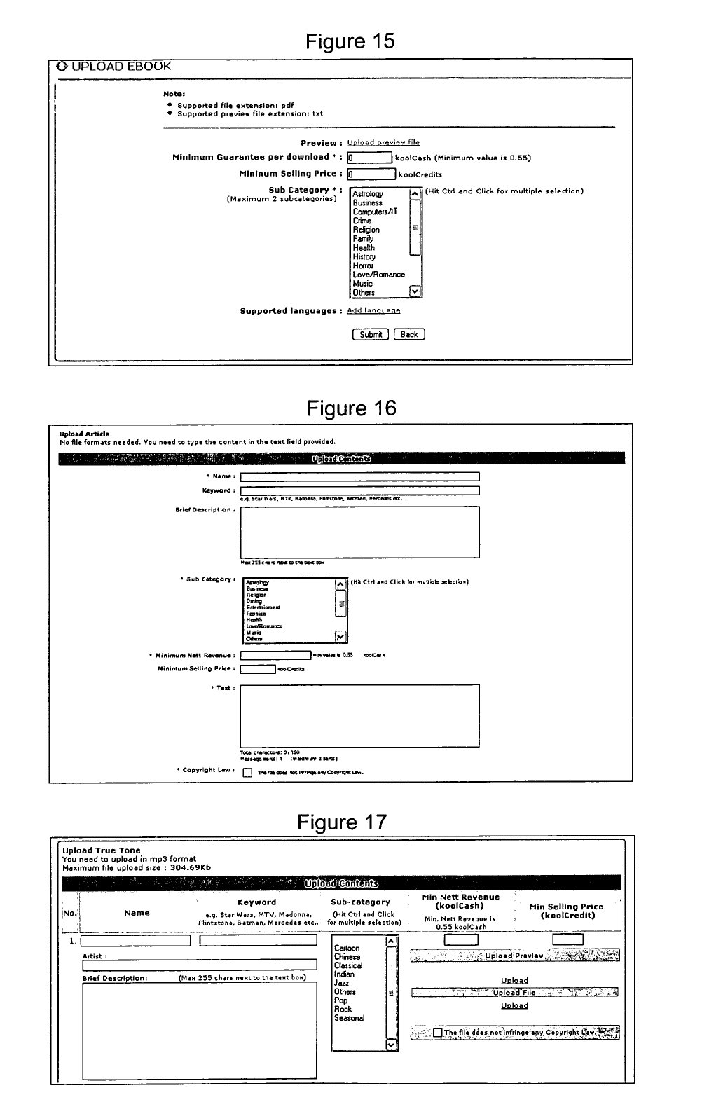

Referring to FIGS. 8 to 17, certain types of digital content are uploadable to a shop in the social marketing network. Once categories are created, a member may upload any created digital content and specify the net minimum guarantee price in virtual money for each sale. The digital content is any one from the group consisting of: ringtone, wallpaper, theme, application, image, audio file, video file, game, and document. Digital content is not restricted to only entertainment and information, but also incorporates research data, market surveys, weblinks, waplinks, and like downloadable digitised content. When uploading digital content, names, keyword search terms, categories, and minimum selling price are also entered. For certain types of digital content, additional information such as description and additional languages are also entered at the time of upload.

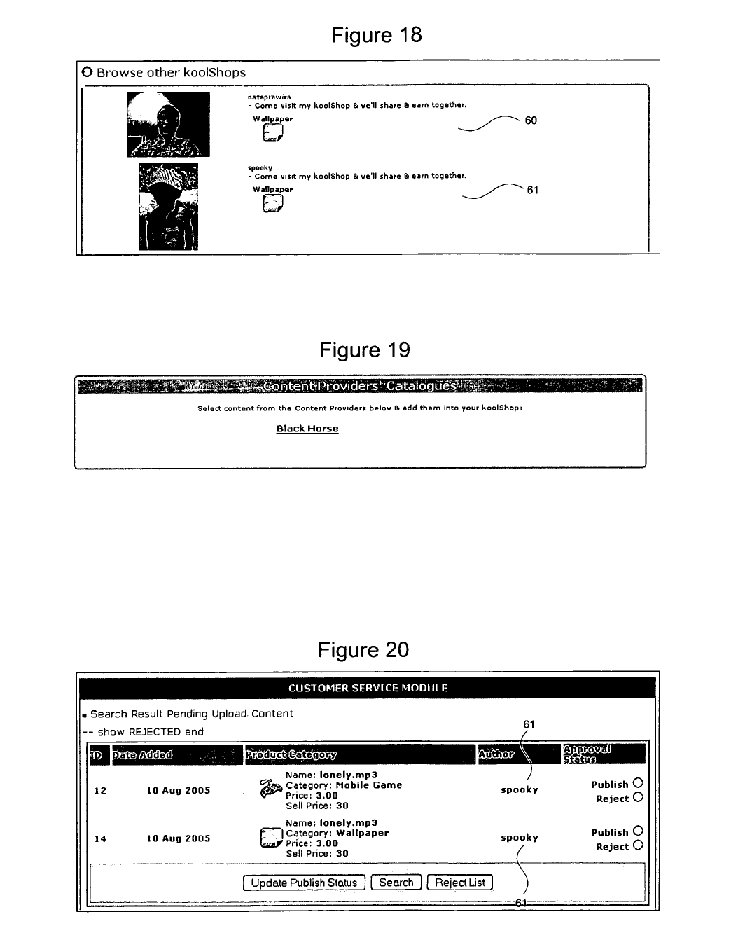

Referring to FIG. 18, members have the ability to browse through other shops in the social marketing network. Referring to FIG. 19, as members browse through other shops, they may come across particular digital content which they think will appeal to visitors of their own shop. Members are able to cross-sell particular digital content obtained from other sources including other member's content or the network partner's content. This presents good cross marketing opportunities for both shops and increased sales.

Referring to FIG. 20, a customer service module enables review of digital content before it is published and made available for sale on a shop. This allows an administrator or operator of the network 5 to check whether the digital content complies with policies of the network 5. The customer service module has four general sections: content approval module, content search module, member account information and resend failed digital content. The content approval module enables the administrator to approve and reject digital content uploaded by members prior to publication. The content search module enables the administrator to search for digital content based on certain search criteria such as category, sub-category and date. The member account information enables the administrator to search for a specific member based on username, e-mail address or mobile phone number. The administrator can also suspend a member from this module. The resend failed digital content enables the administrator to resend digital content to a member if it has failed previously.

The network 5 empowers individuals to innovate, personalize, customize and create digital content quickly in order to share with other each other. To provide and check and balance to this freedom, the customer service module provides a filter to content prior to publication. This enforces the policies of the social marketing network described earlier. However, the customer service module does not hinder the ability of individuals to sign up with the network 5, and directly publish particular digital content for other users in the network 5 without dealing or negotiating with publishers, media and channel owners. Several intermediate layers commonly encountered by content creators when bringing their content to the public have been removed by the network 5 which increases efficiency in content distribution. Also, revenues are maximised or the cost to the consumer is reduced, as commissions which would otherwise have been paid to the intermediate layers are retained. This is a true co-location of the consumer market with a fast reacting and wide supplier base. This enables the network 5 to naturally evolve a content-driven community responsive to popularity, consumer trends and the wider community.

The digital content may incorporate Digital Rights Management (DRM). This enables authors and creators to set limitations on how the digital content is used and how or if it can be copied and accessed. Various pricing policies may be effected together with DRM.

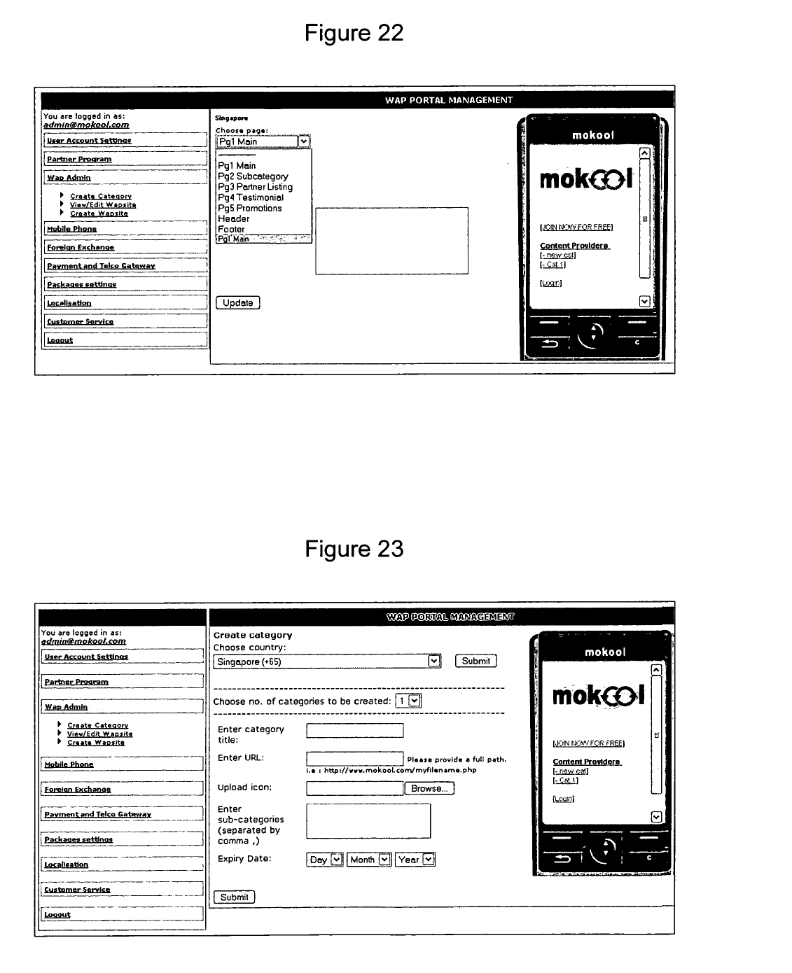

Referring to FIGS. 22 and 23, a billing platform is provided enabling content providers to charge visitors to their content driven web/WAP sites using a variety of established payment options. Payment options include: per event, per duration, fixed price per access, subscription access either daily, weekly, monthly or yearly or such other agreed time period. A portal management module is provided so that content providers can set and create various categories and links they desire and also set the country of origin, countries of publication and various billing options.

Although a first shop 10 has been described, the first shop 10 may also be a lower member of a shop in a higher level in the social marketing network 5.

Although a centralized storage server has been described, it is envisaged that a decentralized storage system may be used. This may facilitate swarming of large files to ease congestion and increase download speeds to end users.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

We claim:

1. A social marketing network for marketing digital content, the network comprising:
a first shop to sell particular digital content;
a plurality of second shops to sell the particular digital content, the second shops being affiliated to the first shop and classified in levels relative to the first shop;
wherein the particular digital content is available for re-sale at any shop within the social marketing network and the revenue earned by the first shop is determined by a predetermined commission scale based on the level of the shop which sold the particular digital content relative to the first shop.

2. The network according to claim 1, wherein an author of the particular digital content receives a predetermined commission rate of the purchase price.

3. The network according to claim 1, wherein the second shops are affiliated to the first shop by any one from the group consisting of: referral or introduction and agreed form of affiliation to the social marketing network.

4. The network according to claim 1, wherein revenue earned from the sale of the particular digital content is paid in the form of virtual money exchangeable for real money after a predetermined waiting period and subject to conditions and policies of the network.

5. The network according to claim 1, wherein the particular digital content is purchased using a form of credit or cash acceptable within the network.

6. The network according to claim 1, wherein the particular digital content is any one from the group consisting of: ringtone, wallpaper, theme, application, image, audio file, video file, game, document, text, a weblink or waplink URL, any form of rich media, and pincodes.

7. The network according to claim 1, wherein the particular digital content is centrally stored to facilitate tracking of the distribution of the particular digital content.

8. The network according to claim 1, wherein the shops are linkable from external sites.

9. The network according to claim 1, wherein if a shop breaches a policy of the social marketing network, the shop is removed from the network and revenue earned by the shop is transferred to an operator of the network in accordance with prevailing network policies.

10. The network according to claim 1, further comprising a customer service module to monitor and filter digital content contravening a policy of the social marketing network, prior to publication for direct sale on the network.

11. A method for earning revenue from selling digital content in a social marketing network, the method comprising:
selling particular digital content from a first shop;
determining the affiliation and the number of levels from the first shop relative to a second shop; and
calculating the revenue earned by the second shop by matching the level of the first shop to a predetermined commission scale;
wherein the particular digital content is available for re-sale at any shop within the social marketing network.

12. An electronic shop for selling digital content, the electronic shop forming a social marketing network, the shop comprising:
a user interface to enable particular digital content to be purchased;
wherein the electronic shop is affiliated to other shops in the social marketing network and classified in levels relative to the other shops; and
the particular digital content is available for re-sale at any shop within the social marketing network and the revenue earned by the electronic shop by purchase of the particular digital content is determined by a predetermined commission scale based on the level of the shop which sold the particular digital content relative to the electronic shop.

13. A billing platform for content providers to earn revenue from sale of digital content, the platform comprising:
a portal management module to establish: categories, links, country of origin and payment options for content driven sites;
wherein visitors to the content driven sites are charged according to the established payment options, the payment options being any one from the group consisting of: per event, per duration, fixed price per access, subscription access either daily, weekly, monthly or yearly or any predetermined time period.

14. The platform according to claim 13, wherein the content driven sites are WAP sites or web sites.

15. The network according to claim 1, further comprising a WAP module to provide ubiquitous connectivity to the network by any device of the group consisting of: mobile phone, PDA, 3G device, interactive television, MP3 player, kiosks and terminals, wherein the WAP module extends the coverage of the network to global mobile communications networks.

16. The network according to claim 1, wherein the shops are WAP sites or web sites.
